(19) United States
(12) Patent Application Publication
(10) Pub. No.: US 2001/0023437 A1
(43) Pub. Date: Sep. 20, 2001

(54) Device for diffusing an occupancy rate of a real or virtual site

(76) Inventors: Aurel Aebi, La Neuveville (CH); Patrick Raymond, La Neuveville (CH); Armand Louis, Neuveville (CH)

Correspondence Address: SUGHRUE, MION, ZINN, MACPEAK & SEAS, 2100 Pennsylvania Avenue, N.W., Washington, DC, 20231, US

(21) Appl. No.: 09/737,779

(22) Filed: Dec. 18, 2000

(30) Foreign Application Priority Data
Dec. 22, 1999 (CH) 2350/99

(51) Int. Cl. G06F 15/173

(52) U.S. Cl. 709/224

(57) ABSTRACT

The invention concerns a device for diffusing at least one item of information characterised in that it includes means for diffusing a signal simultaneously perceptible to a broad public and representative of said information, and in that said information is an occupancy rate of a real or virtual site, in particular a computer network site, particularly of the Internet type.

The invention concerns generally the field of data display.

More particularly, the invention concerns a device for diffusing at least one item of information using a signal perceptible to a human being and representative of the information item.

In the following description, the term “diffusing” means spreading widely the information to make it be perceptible to a large public by ways of sound or light, in the sense of “broadcasting”.

It has been noted that over recent years, the number of Internet sites and its users has greatly increased. For the owners of sites particularly on the Internet it is important to know how popular their sites are to measure the impact that they have on the public. Currently, this information is generally obtained by counting the number of connections or “hits” to a given site since its creation. This information is thus provided in the form of a number generally displayed on the home page of the site concerned. This information and the display mode thereof are limited and do not provide complete satisfaction. Indeed, there is felt among the site owners the need to provide information relating to rate at which their sites are frequented and to be able to provide this information in a more dynamic and vivid way, to communicate a more positive image of the site to the public.

In particular, the display mode used in the prior art has the drawback of only displaying one item of data the evolution of which increases monotonously and which is not representative of the instantaneous frequentation of the site in question. Moreover, the data relating to the numbers of hits since the creation of the site is only displayed on the home page and is consequently only intended for isolated individuals on the site interrogated.

U.S. Pat. No. 5,870,559 concerning a computer programme intended for analysing and managing Internet sites is known. In particular, a plug-in provided to operate with this programme allows the connections effected to a particular address to be counted, corresponding to a particular page of an Internet site, for example, during a time interval pre-defined by the user. However, the result thereby obtained is then displayed, simply in the form of a number, on a page of the main programme showing the plan of the Internet site concerned and limits the spread of this information to a very restricted public, namely a network administrator or webmaster.

The object of the invention is thus to overcome the drawbacks of the aforementioned prior art by providing a device for diffusing at least one item of information representing the instantaneous or quasi-instantaneous frequentation of one or more real or virtual sites, in particular a computer network site of the Internet type, simultaneously to a broad public.

The object of the invention is therefore to make a device for diffusing at least one item of information characterised in particular in that it includes means for diffusing a visual and/or acoustic signal representative of said information, in that said information is an occupancy rate of a real or virtual site, in particular a computer network site, particularly of the Internet type, and in that said signal varies in frequency and/or intensity as a function of said occupancy rate.

As a result of these features, a dynamic item of information representing the occupancy rate can be provided simultaneously to a broad public, such as, for example, in an Internet café.

According to a particular embodiment, the device for diffusing at least one item of information is characterised in that it includes means for transmitting an acoustic signal representing said information item and in that said information item is an occupancy rate of a real or virtual site, in particular a computer network site, particularly of the Internet type.

Thus, the communication of the occupancy rate is provided in a visible manner and/or in another way easily perceptible to the user or to a public present in a given space. The eye and/or the ear receive a dynamic and vivid impression of the occupancy rate of one or more determined sites.

In a preferred variant, the signal is a light signal diffused by the display means in a three-dimensional way so that the information relating to the occupancy rate radiates and fills a given space, in particular a room inside a building intended either for the public or to a determined group of people, in particular the personnel of a company or members of a club.

According to a particular variant of the diffusion device, the latter includes a translucent structure in which means for generating a light signal are arranged.

In order to allow optimum radiation of the light signal in the space in which the display device is located, it is proposed in a variant to suspend the translucent structure above the floor.

Other variants and embodiments, as well as particular advantages of the present invention will be described hereinafter with reference to the description given by way of example and made with reference to the drawing annexed hereto, in which:

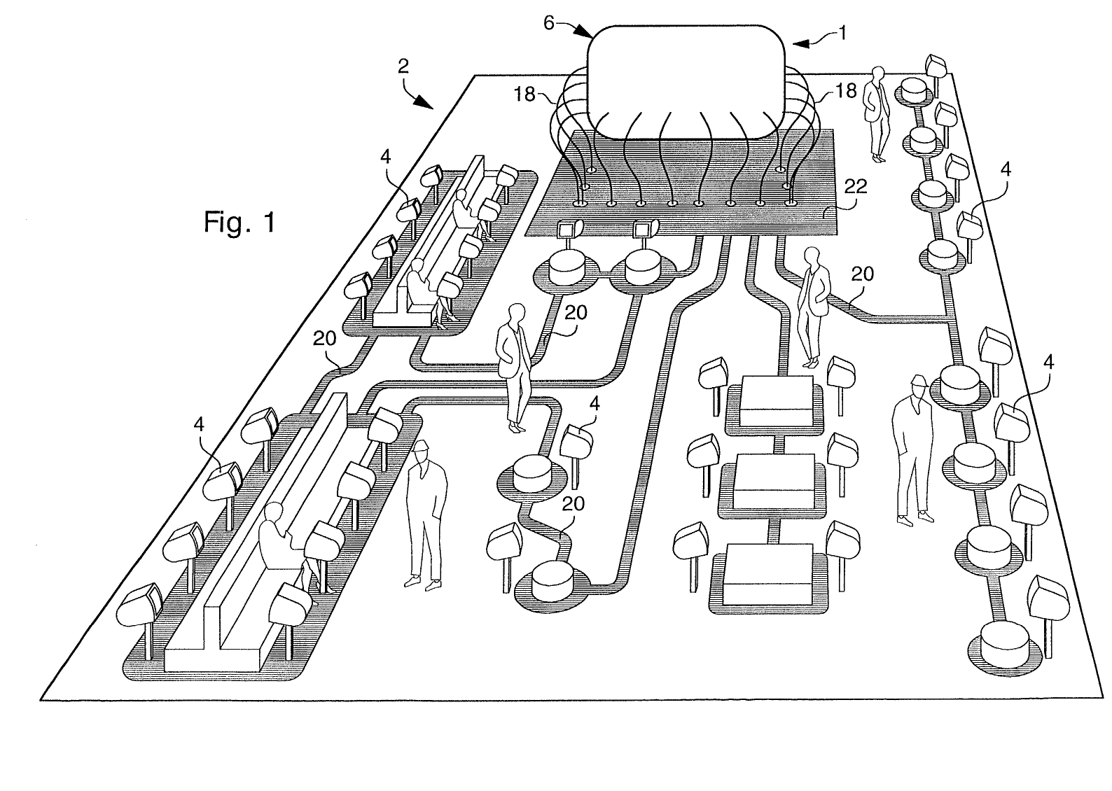

FIG. 1 is a perspective view of a space or meeting place incorporating a first embodiment of the device for diffusing at least one item of information according to the invention;

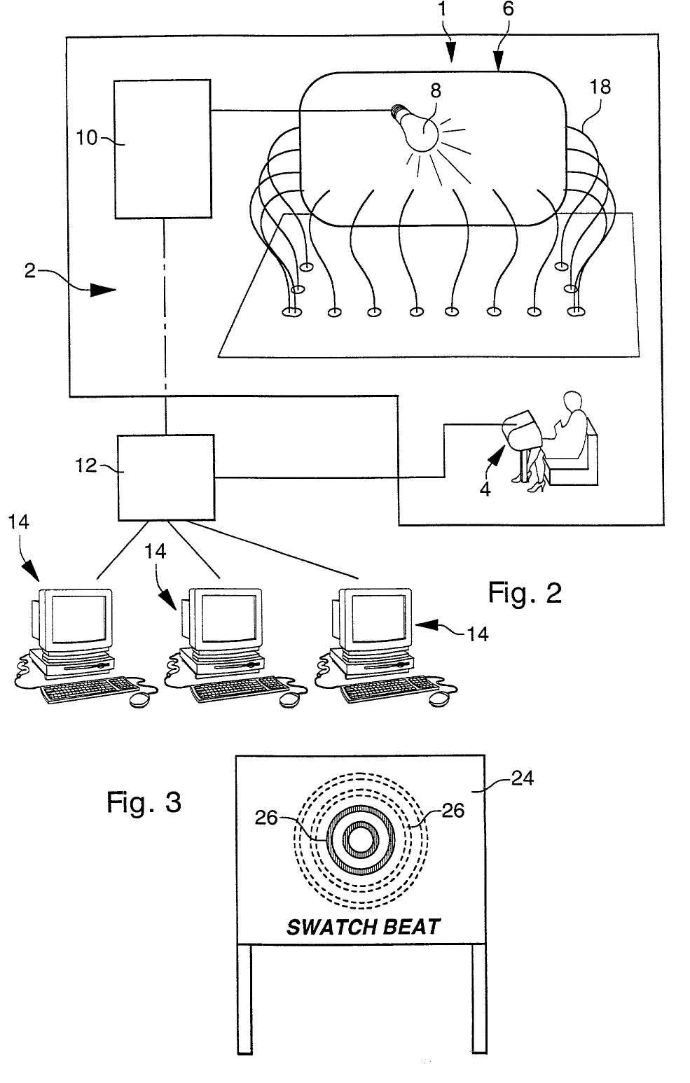

FIG. 2 shows the diffusion device of FIG. 1 with its control device; and

FIG. 3 shows a second embodiment of the device for diffusing at least one item of information according to the invention.

With reference to FIGS. 1 and 2, a first embodiment of the diffusion device according to the invention, which includes a three-dimensional display device designated by the general reference 1, will be described. In the example described, display device 1 is arranged in a meeting place 2 such as a cybercafé or Internet café and allows at least one item of information to be displayed, perceptible, preferably, to all the individuals in meeting place 2.

In a non limiting manner, place 2 further includes a plurality of stations 4 for surfing the Internet.

In this example, the information is presented in the form of a light signal which radiates in all directions or in other words in a three-dimensional way.

According to the invention, the information is an occupancy rate of a computer network site such as an Internet site. “Occupancy rate” means the instantaneous number of connections to this site or the number of connections to this site over a determined period of time, in particular a rolling period. In the latter case, the rolling period can be defined by the last five minutes so that the information displayed by the device permanently represents the number of connections over the last five minutes.

Device 1 thus allows the evolution of the occupancy of an Internet site to be displayed dynamically, which makes this information particularly vivid and attractive.

In this first embodiment, display device 1 includes a translucent structure 6 in which are arranged one or more light sources, represented in FIG. 2 by a light bulb 8, which form the means for generating light signals. Structure 6 is for example formed by a shell made of a transparent or translucent material such as polymethylmethacrylate (PMMA). Light sources 8 can be formed by any means known to those skilled in the art such as incandescent lamps or luminous diodes. Light sources 8 are connected to control means 10 which are in turn connected to a server centre 12 to which stations 4 and computers 14, located outside meeting place 2, can be connected.

In this embodiment, the frequency of the light signal varies as a function of the occupancy rate. According to an alternative embodiment, the intensity of the light signal can be varied to represent the occupancy rate. Server centre 12 includes means for calculating the number of instantaneous connections or connections over a constant time interval (rolling period) to a given site and means for providing a signal representative of this connection number which is transmitted to control means 10. These control means are arranged to control the power supply of the light signal generating means, in particular to vary the frequency or the intensity of the light signal as a function of the alternative embodiment selected.

In the example shown translucent structure 6 is suspended above the floor by means of a plurality of elements or rigid or semi-rigid support legs distributed over its periphery. Preferably, structure 6 is suspended at a height such that it allows people to move around underneath it. The translucent structure-support legs assembly takes the general form of an integrated circuit with its connecting wires. According to an alternative embodiment, support legs 18 form light wave guides which radiate.

Moreover, the floor of meeting place 2 calls to mind a printed circuit with its connection paths 20 which physically connect the various stations 4 to a surface 22 symbolising a connection pad with the translucent structure-support legs assembly.

FIG. 3 shows a second embodiment of the diffusion device according to the invention which takes the form of a display table 24. This table 24 includes a plurality of discrete light sources 26 which can be activated selectively by the control means (not shown) so that the illuminated zone extends over a variable surface representative of the occupancy rate of a determined Internet site.

Of course, the diffusion device according to the invention is not limited to the embodiments described hereinbefore. Indeed, the visual signal may be replaced by an acoustic signal or both of the signals could be combined.

What is claimed is:

1. A device for diffusing at least one item of information including means for diffusing a visual and/or acoustic signal representative of said information, wherein said information is an occupancy rate of a real or virtual site, in particular a computer network site, particularly of the Internet type, and wherein said signal varies in frequency and/or intensity as a function of said occupancy rate.

2. A device for diffusing at least one item of information, including means for transmitting an acoustic signal representative of said information, wherein said information is an occupancy rate of a real or virtual site, in particular a computer network site, particularly of the Internet type.

3. A diffusion device according to claim 1, wherein the diffusion means include a support formed of a plurality of discrete light sources and wherein the number of sources activated varies as a function of the occupancy rate.

4. A diffusion device according to claim 1 or 2, wherein said visual signal is a light signal.

5. A diffusion device according to claim 4, wherein said diffusion means radiate said light signal in a three-dimensional way.

6. A diffusion device according to claim 1 or 3, including a translucent structure in which are arranged at least the means for generating a light signal.

7. A diffusion according to claim 2, including a translucent structure in which are arranged at least the means for generating a light signal.

8. A diffusion device according to claims 6 or 7, wherein said structure is suspended above the floor.

9. A diffusion device according to claim 8, wherein said structure is supported above the floor by a plurality of rigid or semi-rigid support elements.

10. A diffusion device according to claim 9, wherein said translucent structure-support element assembly has the general shape of an integrated circuit with its connecting wires.

11. A diffusion device according to claim 9 or 10, wherein said support elements are arranged to form radiating light wave guides.

12. A diffusion device according to claim 8, wherein it is arranged above the floor at a height such that it allows people to move around underneath it.
